(19) United States
(12) Patent Application Publication
(10) Pub. No.: US 2007/0136657 A1
(43) Pub. Date: Jun. 14, 2007

(54) Process for Automatic Data Annotation, Selection, and Utilization.

(76) Inventors: Daniel Blumenthal, Newton, MA (US); Fred Egan, York Harbor, ME (US)

Correspondence Address: JOHN ALEXANDER GALBREATH, 2516 CHESTNUT WOODS CT, REISTERSTOWN, MD, 21136, US

(21) Appl. No.: 11/679,116

(22) Filed: Feb. 26, 2007

Related U.S. Application Data
(63) Continuation-in-part of application No. 11/376,361, filed on Mar. 15, 2006.
(60) Provisional application No. 60/665,527, filed on Mar. 25, 2005.

(51) Int. Cl. G06F 17/00; G07G 1/14

(52) U.S. Cl. 715/512; 705/14; 715/530

(57) ABSTRACT

Systems and methods for the automatic annotation of data are disclosed, particularly a process and system for enabling users to generate automatic annotations, to select one or more of those annotations, and to utilize the selected annotations and their various relationships to the annotated data. Also disclosed are ways to utilize selected online annotations in the form of promotional material, so that the user can manage the online promotional material he/she selects, and obtain various advantages therefrom.

### CROSS-REFERENCES TO RELATED APPLICATIONS

This patent application is a continuation-in-part of U.S. patent application Ser. No. 11/376,361, filed Mar. 15, 2006 and titled “Process for Automatic Data Annotation, Selection, and Utilization”, and claims priority from, and the benefit of, that parent application. In turn, that parent application claims priority from, and the benefit of, provisional U.S. patent application Ser. No. 60/665,527, filed Mar. 25, 2005 and titled “Process for Automatic Data Annotation, Selection, and Utilization”. The disclosures of said applications and their entire file wrappers (including all prior art references cited therein) are hereby specifically incorporated herein by reference in their entirety as if set forth fully herein. Furthermore, a portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

1. Field of the Invention

The disclosed systems and methods relate generally to the automatic annotation of data, particularly to a method for enabling users to generate automatic annotations, to select one or more of those annotations, and to utilize the selected annotations and their various relationships to the annotated data. The disclosed systems and methods also relate to the generation of automatic annotations in the form of promotional material (including but not limited to advertisements, coupons, and the like) on a webpage or other collection of data, and the selection and utilization of the online promotional material by the user/viewer of the promotional material.

2. Description of the Related Art

The process of merely annotating Internet websites is known in the prior art; for examples, see the websites www.rikai.com and www.popjisyo.com. However, these websites do not allow the user to select, collect, and/or collate the annotations that are made, as in the process of the present invention. Instead, the annotations in these prior art websites are purely for reference—these websites do not allow the user to do anything with the annotations.

This is an important difference between the prior art and the present invention, because the real power and value of the invention comes not from merely annotating in the conventional sense. Rather, the invention provides for distinctive types of annotation, and then allows the user to select and utilize the annotation to increase his learning or perform a task.

Similarly, although online advertisements are ubiquitous, previously the advertisement viewer (i.e., the prospective customer) has not been able to track or manage the advertisements he/she selects. Instead, that has been the province of the advertisers themselves, the owners of the websites on which the advertisements are displayed, and/or other third parties.

### SUMMARY OF THE INVENTION

The invention is a process that automatically annotates arbitrary collections of data, and then allows users to cull from the annotated data those words, phrases, sentence constructions, numbers, references, etc., which they wish to examine more closely. The process thus provides a mechanism by which users may study, learn, or otherwise utilize the specific materials they have selected from the annotated data. In the online promotional material arena, the invention also includes generating automatic annotations in the form of promotional material (including but not limited to advertisements, coupons, and the like) on a webpage or other collection of data, and then allowing a user to utilize and otherwise manage the promotional material annotations he/she selects. The selection and utilization aspects of the invention include methods for allowing users to utilize promotional material that has been placed on a webpage or other collection of data not by the invention, but by another party. Said another way, the selection and utilization aspects of the invention apply to promotional material that the invention placed as an annotation on a website or other collection of data, but also to promotional material that another party (the website owner, advertiser, etc.) placed as an annotation on a website or other collection of data.

A broad object of the invention is to allow users to utilize the information imparted by an annotation to perform a task—i.e., not just annotating for reference.

A more specific object of the invention is to allow users to increase their knowledge of annotated terms in a foreign-language data collection such as a webpage, newspaper, etc., by providing translations when an annotated term is selected.

A further object of the invention is to allow users to test their knowledge of the annotated terms, by allowing users to add selected annotated terms to a vocabulary list, and subsequently test their knowledge of that list (annotated terms and associated translations) by taking a vocabulary test.

A further object of the invention is to provide a process and system that can be used to annotate many different forms of data, including but not limited to webpages, text, speech, spreadsheets, musical recordings, computer files, etc.

A further object of the invention is to provide a process and system that can annotate data in many different ways, including but not limited to highlighting, graphics, audio or video indications, highlighting, etc.

A further object of the invention is to provide a process and system that can provide information to a user in a variety of ways when the user selects an annotation, including but not limited to visual, tactile, auditory, olfactory, and taste-related feedback.

A further object of the invention is to provide a process and system wherein users can track, manage, and otherwise utilize the online promotional material he/she selects.

A further object of the invention is to provide a process and system wherein a user can share the promotional material he/she selects, and associated information, with others.

A further object of the invention is to provide a process and system wherein a user can access promotional material that has been selected by others, along with associated information.

Further objects and advantages of the invention will become apparent from a consideration of the ensuing description and drawings.

### DESCRIPTION OF THE DRAWINGS

FIG. 1 is a flow diagram that illustrates the basic steps and principles in the process of the invention.

FIG. 2 shows an entry screen for specifying a website to be annotated.

FIG. 3 shows a screen with one frame containing a list of selected items, and another frame which contains the annotated text of the website.

FIG. 4 shows a pop-up box with annotations relating to the highlighted text.

FIG. 5 shows a quiz screen.

FIG. 6 shows a notification of an incorrect answer on the quiz screen.

FIG. 7 is a flowchart illustrating the steps in the process of the invention wherein user-selected advertisements are stored, accessed, and managed. This is the embodiment wherein the promotional material has been placed as an annotation by another party.

FIG. 8 is a diagram illustrating the various action steps a user can take to manage his/her promotional material.

FIG. 9 is a diagram illustrating how multiple users interact with a social bookmarking website or other central repository of advertisement data.

FIG. 10 illustrates the various steps that a user can take to access the promotional material-related information of other users.

FIG. 11 is a flowchart illustrating the steps in the process of the invention wherein promotional material is annotated onto the webpage by the invention, and then selected, stored, accessed, and managed by the user.

### DETAILED DESCRIPTION OF THE INVENTION

The following provides a list of the reference characters used in the drawings:
10. Data collection
11. Analysis and annotation step
12. Database
13. Presentation step
14. Selection step
15. Utilization step
16. URL address
17. Translate-from drop-down menu
18. Annotation
19. Pop-up box
20. Gender
21. Translation
22. List of selected items
23. Quiz
24. Foreign language word
25. Space
26. Correct answer
27. Translate-to drop-down menu
28. “Add this word to the test” button
29. “Start the test” button
30. “Analyze” button
31. Promotional material selecting step
32. Promotional material storing step
33. Promotional material accessing step
34. Promotional material deleting step
35. Promotional material saving step
36. Promotional material organizing step
37. Promotional material tagging step
38. Promotional material/promoter rating step
39. Promotional material/promoter reviewing step
40. Promotional material/promoter ranking step
41. Promotional material bookmarking step
42. Thematic list creation step
43. Sharing step
44. Social bookmarking website
45. Search other users' promotional material step
46. Search for other users step
47. Search for particular users step
48. Bookmark user step
49. Search for other bookmarked users step
50. Receive suggestions step
51. Promotional material utilizing step

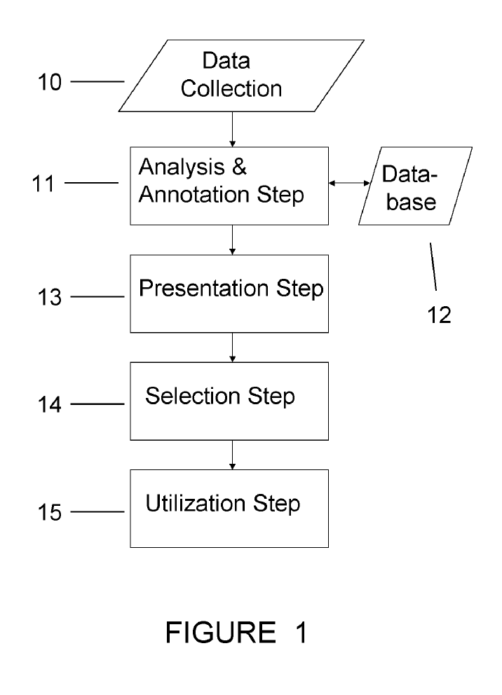

FIG. 1 diagrammatically illustrates the basic steps and principles in the process. A user, autonomous or semi-autonomous agent, or automated process specifies a data collection 10 to be annotated. Data collection 10 could comprise a web page, text directly input for annotation, speech, mathematical formulas, a spreadsheet, lists or graphs of numbers, musical recordings, sheet music, speech, one or more computer files or print documents, databases, data culled from medical equipment, data specified by another method, or any combination of these. Data collection 10 could be complete at the time of specification, or it could be a continuous or discontinuous stream of data being received in real-time (e.g., a simultaneous interpreter could configure a software implementation to annotate a speech as it is being made).

Data collection 10 first undergoes a data analysis and annotation step 11. In analysis and annotation step 11, pieces of data collection 10 are compared against information in database 12, said database 12 being internal or otherwise accessible to the process. When a connection, association, or correlation is found between a particular piece of data collection 10 and information in database 12, that piece of data is annotated to reference the information.

The following describes an example of one way in which analysis and annotation step 11 could be performed. A user, interacting with a web site, would specify the URL of an English-language website to be annotated in Spanish. This URL would be communicated to a web server running a Java servlet, which would read the website specified by the URL. Having read the site into memory, the servlet would then interface with a database (also on the server), and analyze the website in the following way: first, it would look for logical breaks in the data based on punctuation, line breaks, and formatting data. For each of the resulting pieces of data, it would search for matching or correlating entries in its internal or otherwise accessible database.

For example, let's say the phrase “The quick brown fox jumps over the lazy dog” is a piece of data identified in the data collection to be annotated. The servlet would first search its database of words and phrases for “the quick brown fox”. Note that the servlet could search for more or less than four words at a time (out of the total nine words in the phrase), based on user preference, processor speed, or other reasons. Likewise, analysis could be based on sentence structure, context, formatting, contiguous or non-contiguous text, or other factors. If “the quick brown fox” wasn't found, the servlet would then search for “the quick brown”. If that also wasn't found, the servlet would search for “the quick”. If this were found then it would annotate “the quick” with the corresponding text in the desired language—say, Spanish.

Then, “the quick” having been found and annotated, the servlet would start over with the remaining seven words in the original nine word phrase—that is, “brown fox jumps over the lazy dog”. Again taking a four-word “chunk”, the servlet would first search for “brown fox jumps over”, then “brown fox jumps”, then “brown fox”, then “brown”. If none of these were found, then it would leave “brown” alone (i.e., not annotate it), and continue on with “fox jumps over the lazy dog”. Note that this is only one example of an algorithm controlling how the collection of data is compared to internal databases during the annotation step. Certainly, other algorithms could be used, such as one that takes each individual word in the collection of data and compares it to words in the internal database.

When analysis and annotation step 11 is complete, and no further connections, associations, or correlations can be found between data collection 10 and information in database 12, the Java servlet returns the annotated data to the user, including any appropriate HTML markup, in presentation step 13. The process can visually display the annotated data collection to the user, or present the annotations in some other suitable way.

The user then selects an annotation or annotations in selection step 14, e.g., by moving the cursor over the annotation to see relevant information or see possible options for taking an action like adding the annotation to a list. In utilization step 15, the user then takes an action based on the information or possible options revealed in selection step 14. The user thus uses the annotations—for example, by adding annotation 18 to a list. The user can subsequently take additional actions related to the annotations, like taking a vocabulary test of the annotated words that were added to the list.

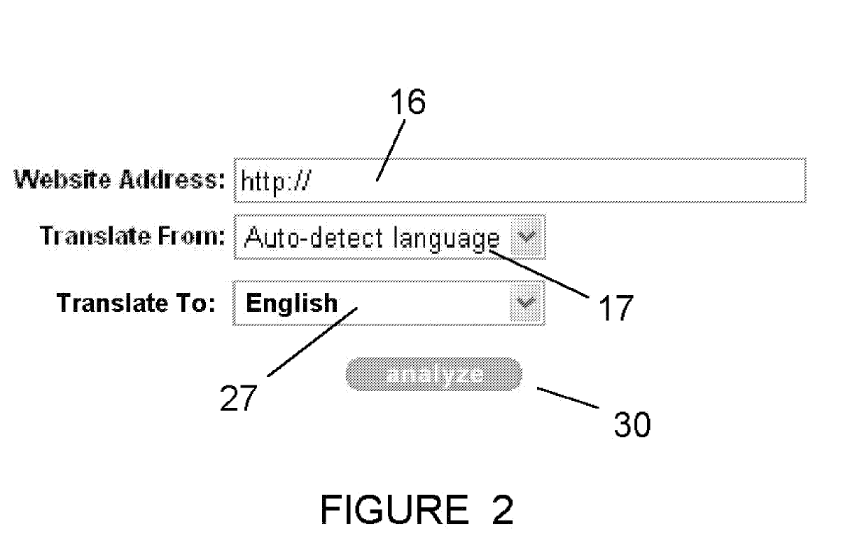

FIG. 2 shows an example of specifying a data collection 10, wherein an entry screen allows a user or agent to specify the URL address 16 for a webpage to be annotated, and to optionally specify the language of the webpage via a translate-from drop-down menu 17. Using translate-from drop-down menu 17, a user could specify that the webpage was in Spanish, French, or some other language, or alternatively could specify that the process automatically detect the language of the webpage. The user can also specify the language in which the annotations will be presented, via translate-to drop-down menu 27. After the user has entered the above inputs, he clicks on “Analyze” button 30 to start analysis and annotation step 11.

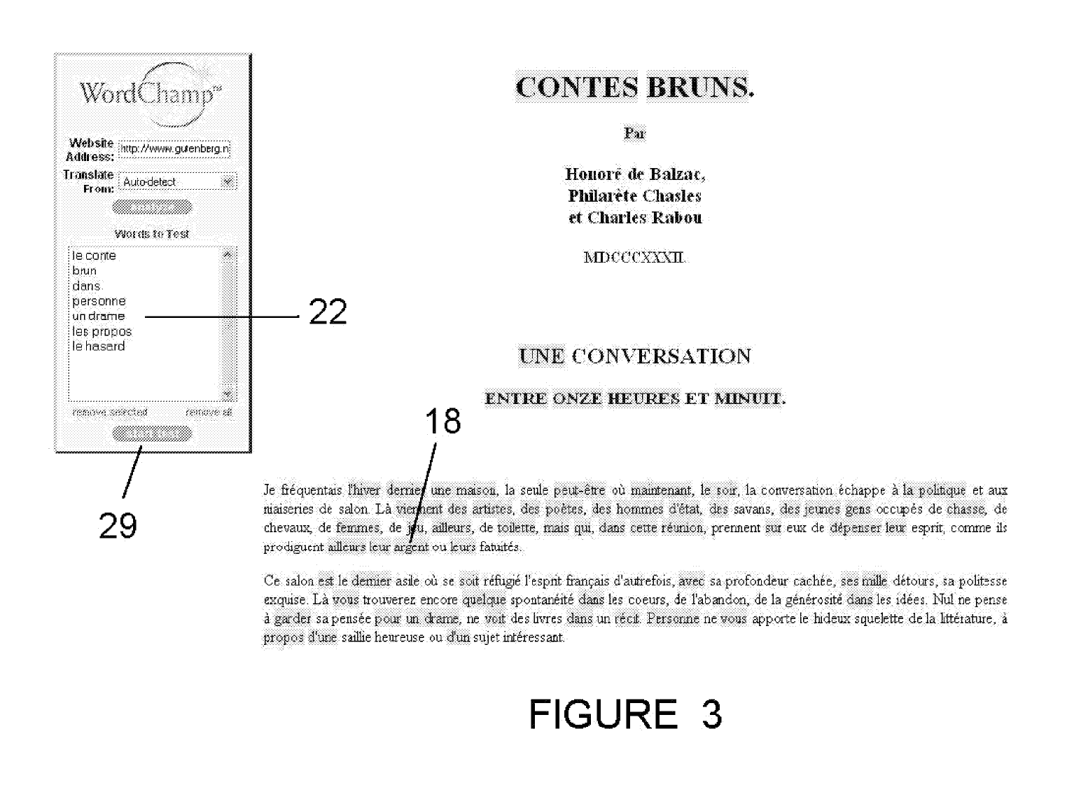

FIG. 3 shows an example of a webpage which has undergone analysis and annotation step 11, and has been displayed to the user in presentation step 13. In this example, the annotations are indicated by highlighted text, including a particular annotation 18 relating to the French word “argent”.

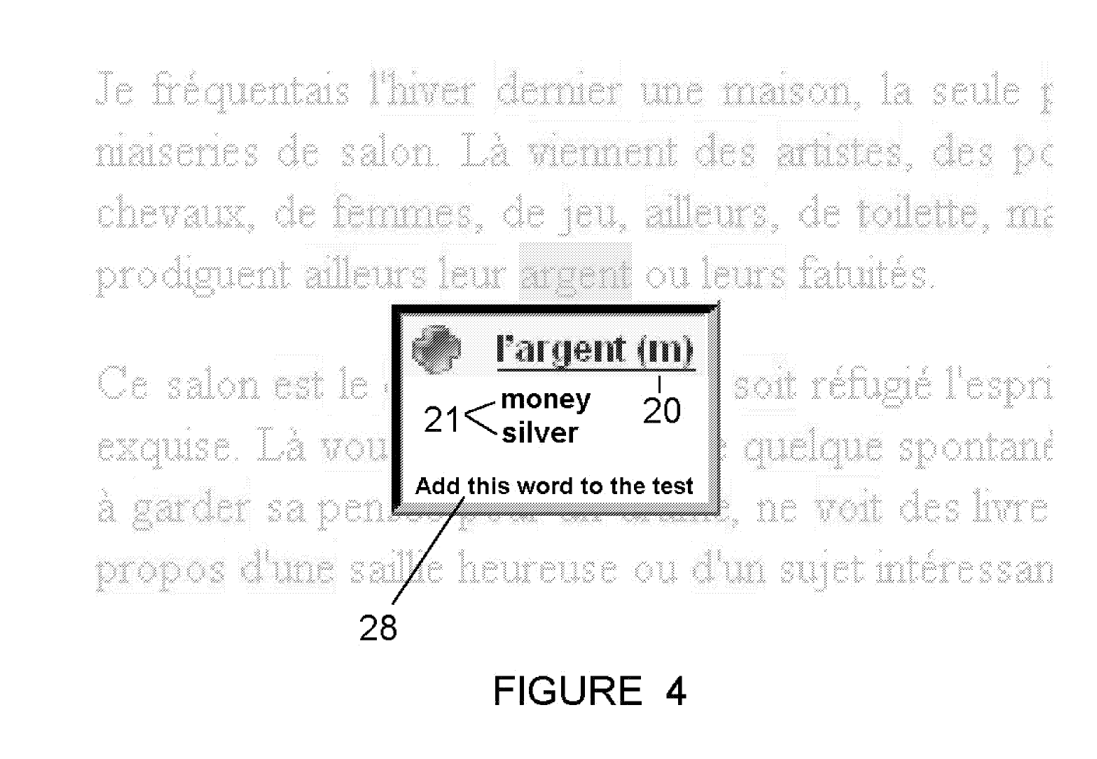

In selection step 14, the user moves the cursor over the annotated text, and a pop-up box containing information related to annotation 18 appears. FIG. 4 shows such a pop-up box 19, with information including the French word's gender 20 and English translation 21. An “Add this word to the test” button 28 appears along with the other information in pop-up box 19. A user could alternatively select an annotation by clicking on a hyperlink, voice command, eye tracking device, joystick, electroencephalograph, or other method. A user could select one or more annotations, all annotations simultaneously, or set up an automated process to select a particular type of annotation (e.g., references to case law, intransitive verbs, etc.).

FIG. 3 also shows an example of utilization step 14. In this example, when the user selects the annotation by moving the cursor over a piece of annotated text, the user can then choose to take an action related to the annotation—for example, the user can choose to click on “Add this word to the test” button 28 and add the annotated text to the list of selected items 22. It can be appreciated that other actions can be taken by the user based on the information provided by annotation 18, and examples of such other actions are described later in this disclosure.

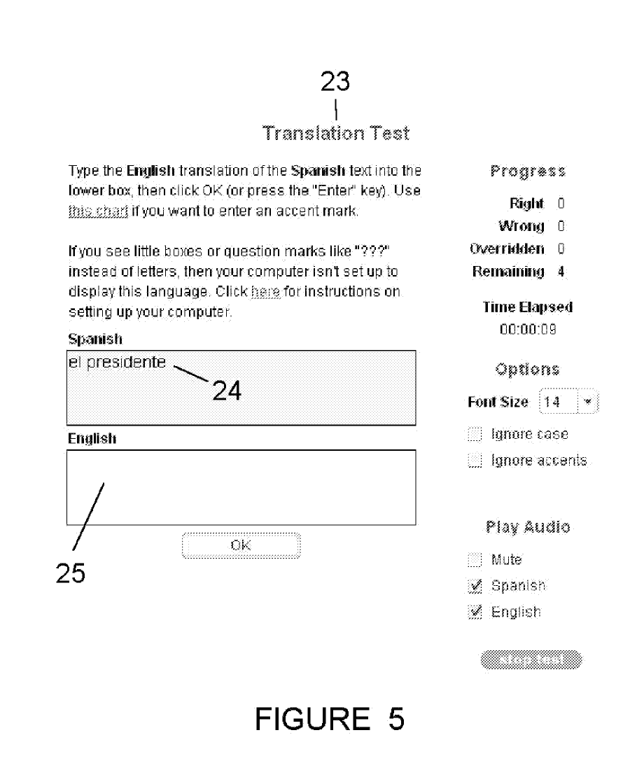

The user can also take additional actions related to the annotations, and FIG. 5 shows one such example. A quiz 23 is automatically generated from a list of selected items, such as the list of selected items 22 shown in FIG. 3. (Note, however, that the FIG. 5 quiz tests knowledge of Spanish words, whereas in FIG. 3 the selected words are French.) The user clicks on a “Start test” button 29, and is presented with a foreign language word 24 (here, “el presidente”), and required to correctly enter the translation in the provided space 25. If the user enters the correct response, foreign language word 24 is removed from the list and quiz 23 moves to the next question.

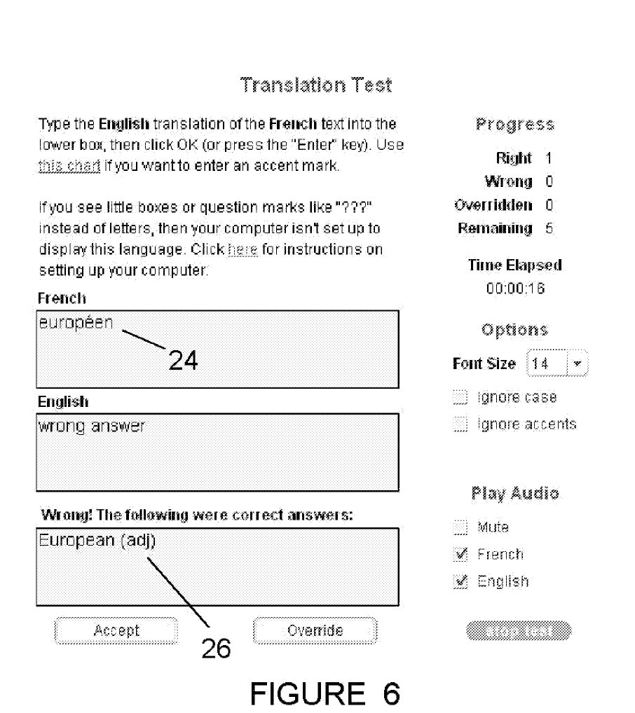

If an incorrect answer is entered, then, as shown in FIG. 6, the user is provided with the correct answer 26 before quiz 23 continues. (Note that FIG. 6 provides a correct English translation of the French word “européen”, rather than the Spanish word “el presidents”. ) Quiz 23 could return an incorrectly answered question to the list, either at a predetermined or random location. Alternatively, it could add an incorrectly-answered question back into the list at multiple locations, in order to force the user to answer correctly multiple times. The determination of location could be random, or at specific intervals to correspond to the points at which short-term memory is exhausted, in order to make sure the correct answer is entering long-term memory. It could be presented to the user after a particular amount of time has elapsed, or, more simply, added back into the list of remaining questions at a pre-determined location, and at the end of the list.

### Selection and Utilization of Online Promotional Material

With regard to annotations that take the form of online promotional material, it is common in the Internet industry for website owners and advertisers to place advertisements on their own and third party web pages, according to a variety of algorithms. These algorithms involve analyzing the web page, and placing advertisements that are related to the content of the page. Thus, online advertisements can be seen as an embodiment of an automatic annotation process, wherein text, images, formatting, and other content are analyzed, and relevant annotations are placed in and around the content. In addition to web pages (including blogs, email, forums, and other user-generated content), this could also be applied to parts of web pages, text, documents, spreadsheets, instant messaging, mobile phone messages, calendar entries, audio streams or files, medical charts, electronic books or e-paper, etc. In sum, the methods and systems of the invention include a variety of ways that a user can manage the promotional material annotations that he/she selects online, including the following:

Generating a List/History of Previously-Selected Promotional Material

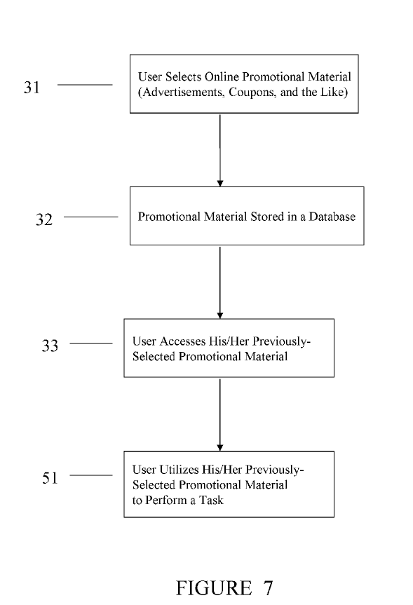

As shown in FIG. 7, in promotional material selecting step 31 a user selects online promotional material by clicking on it—in other words, all promotional material that is clicked on (i.e., the hyperlink is followed) is selected automatically. In an alternative embodiment, all promotional material clicked on is not selected and stored automatically, but rather is selected and stored if the promotional material fits certain user-defined criteria. In another alternative embodiment, the promotional material is selected by clicking on an additional “selection” link associated with the promotion material, such that the user clicks on the primary promotional material link to go to the underlying website, and clicks on the “selection” link to select and store the promotional material without going to the underlying website. In another alternative embodiment, the user clicks with the left mouse button to go to the underlying website, and clicks on the right mouse button to select and store the promotional material without going to the underlying website, or vice-versa.

FIG. 7 illustrates the embodiment wherein the promotional material includes an online advertisement, coupon, or the like that another party has placed as an annotation. For advertisements placed on websites by an advertisement broker (e.g., Google, doubleclick, etc.), the links included in the advertisements will be to the advertisement broker, which will record the click and then redirect the user to the advertiser. In the case of known advertisement brokers, these can be identified by the target hyperlink, and the invention keeps a database of these hyperlinks for identification purposes.

Alternatively, a special marker can be placed in the advertisement by advertisement brokers or websites that want to enable the type of service provided by the invention. On the client side, this can be in the form of a specially-named HTML block, a CSS class, a list defined in Javascript, VBScript or other client-side scripting language, or other method. On the server side, it could be communicated via HTTP, TCP/IP, remote procedure call, SOAP, etc. As another alternative, a heuristic can be employed that would look for advertisements based on one or more of the following criteria: link to another site, structural displacement from the rest of the text (block-level element, border, background color, image, flash movie, etc.), text (“ad”, “advertisement”, “sponsored links”, etc.), and so forth. For non-website data such as an audio/video stream, there are known solutions for identifying commercials and other promotional material. In sum, the identification of the promotional material placed on a website or other data collection by another party can be accomplished by one of the above-described methods, or by any other suitable means known in the art.

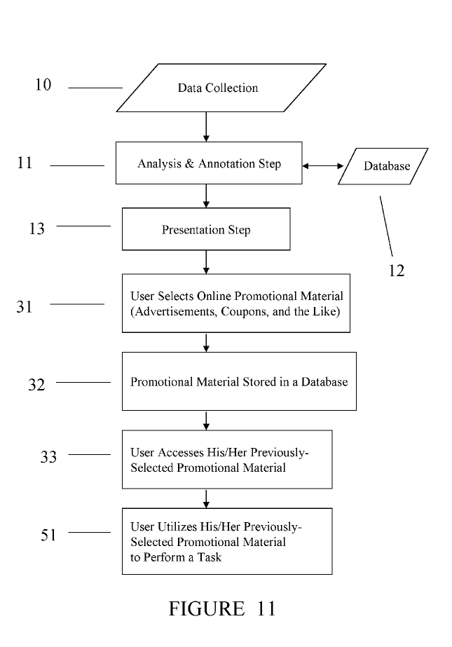

FIG. 11, further described below, illustrates the embodiment wherein the promotional material has been placed as an annotation by the invention. In promotional material storing step 32, the promotional material is stored in a database, file system, cookies, session, or other data storage means—either automatically, by one of the methods described above, or by the user specifically requesting storage of the promotional material by clicking on a “Yes” button on a pop-up window that appears after the promotional material is selected. The database where the promotional material is stored can be database 12, or alternatively it can be a separate database. It should be understood that any and all information relating to the promotional material can be stored, including but not limited to the audio, visual, olfactory, tactile, and/or taste content; the hyperlink; text related to the ad; meta-data such as promotions, coupons, references to or text from user or trade reviews, brochures, commentaries, or other supplementary material; and/or contextual information, including but not limited to the annotated data, criteria, and notes or code from the annotation process (to allow the user or an automatic process to re-annotate using revised criteria). Then at a future time in promotional material accessing step 33, the user accesses the promotional material, along with other promotional materials he/she has previously selected, by navigating to a special webpage that displays a list of the user's previously-selected promotional materials. In promotional material utilizing step 51, the user takes various actions to utilize the promotional materials he/she has selected, with or without additional information associated with the promotional materials, to perform a task.

Performing Various Actions on Promotional Material in the List

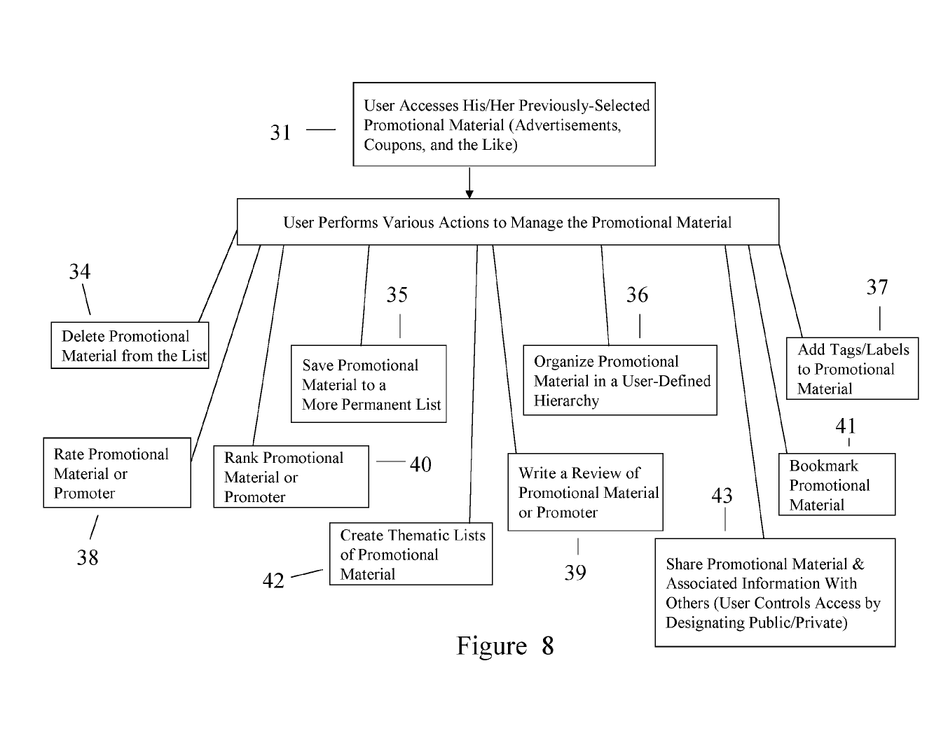

As shown in FIG. 8, after navigating to the special webpage and viewing the list mentioned above, the user is presented with links, buttons, or other methods by which they can select an action that relates to one or more of the selected promotional materials on the list. In one embodiment, one or more links or buttons corresponding to actions are displayed next to each piece of selected promotional material. In another embodiment, the user marks one or more pieces of promotional material for an action, and then presses a link or button to perform the action. For example, in promotional material deleting step 34 the user clicks on checkboxes next to one or more promotional materials to mark those promotional materials, and then clicks a “delete” button to delete them from the list. The promotional material can be permanently erased, or go into a “trash” folder, from which it can be later retrieved. Alternatively, instead of marking checkboxes and clicking a delete button, the user can drag-and-drop promotional material into a trash folder or similar receptacle.

Examples of Other Actions that the User can Perform are:

By performing promotional material saving step 35, the user can save the promotional material to a more permanent list (if, for example, the promotional material was in a “temporary holding bin”, awaiting an action).

By performing promotional material organizing step 36, the user can move the promotional material to a location in a user-defined hierarchy, dragging and dropping one or more promotional materials into a folder, selecting a target destination from a drop-down hierarchical menu, or other method.

By performing promotional material tagging step 37, the user can add tags or labels to the promotional materials, by entering text into a box, selecting from user—or pre-defined categories, dragging tags onto the promotional material, or other method. Promotional materials that have been tagged with one or more descriptive words associated can be thereafter searched by the user. For example, the user can search his list of previously-selected promotional materials for all promotional materials having a Nike® or Coca-Cola® tag. The tagging functionality is useful for finding a particular piece of promotional material or set of promotional materials from a long list of previously-selected promotional materials.

By performing promotional material/promoter rating step 38 or promotional material/promoter reviewing step 39 respectively, the user can rate the promotional material or the promoter, or write a review of the promotional material or the promoter, by clicking on a button, moving a slider, selecting from a drop-down menu, clicking on a radio button, entering descriptive text, or other method. Promotional material can be rated by content, relevance of promotional material to original search terms, prose style, pictures, adult content, or on characteristics of the promoter, including but not limited to price, product/service quality, quality of service, ease of use, degree of family-friendliness, helpfulness, category of product/service, etc. Promoters can include advertisers, coupon distributors, merchants, and the like. In addition to rating promotional materials or promoters by various criteria, by performing promotional material ranking step 40 the user can also rank his/her promotional materials or promoters, based on the relative ratings discussed above or simply on the user's less-quantitative judgment (e.g., #1, #2, #3, etc.). A user can also associate hyperlinks to related promotional materials, news stories, blogs, online articles, comic strips, or other webpages.

By performing promotional material bookmarking step 41, the user can place one or more promotional materials in a list of bookmarks. This list of bookmarks is stored in a file on the user's computer, in cookies, in a database on a web server, or in some other location. The bookmarks can be visible to other users, or alternatively can be hidden. The user can also create multiple lists of bookmarks, each with a different theme. The list of bookmarks resides on the special webpage; however, it should be understood that the list of bookmarks can alternatively reside elsewhere, such as on another webpage or website. In this latter embodiment, the list of bookmarks feeds into a social bookmarking website 44, such as that exemplified by the website http://del.icio.us. In a third embodiment, the promotional material bookmarking functionality is built directly into the web browser. In this embodiment, the user bookmarks promotional material by clicking on a “Favorite Promotional Material” browser tab and then clicking on “Add Promotional material” in a drop-down menu. The user thereafter accesses his/her list of bookmarked promotional material by again clicking on the “Favorite Ads” browser tab.

Creating Thematic Lists of Promotional Material

Continuing with FIG. 8, by performing thematic list creation step 42 the user can create multiple different lists previously-selected promotional material, each list corresponding to a particular theme. The user creates these multiple lists in advance of actually selecting a promotional material, such that when selecting the promotional material, the user assigns the promotional material to the appropriate list. The user can also create multiple, differently-themed lists of promotional material from an existing overall list on the special webpage, by creating a new themed list and moving one or more promotional materials to it. Many different themes are envisioned, including but not limited to: by company (e.g., Nike® or Coca-Cola®), by product/service (the advertised product or service); by location (e.g. Northeast, West Coast, Europe, etc.); by language; by type of promoter (e.g. website, brick-and-mortar, for-profit, charity, etc.); by degree of the user's interest (e.g. high, medium, low); or by various user-defined categories.

Sharing Promotional Material and Lists of Promotional Material

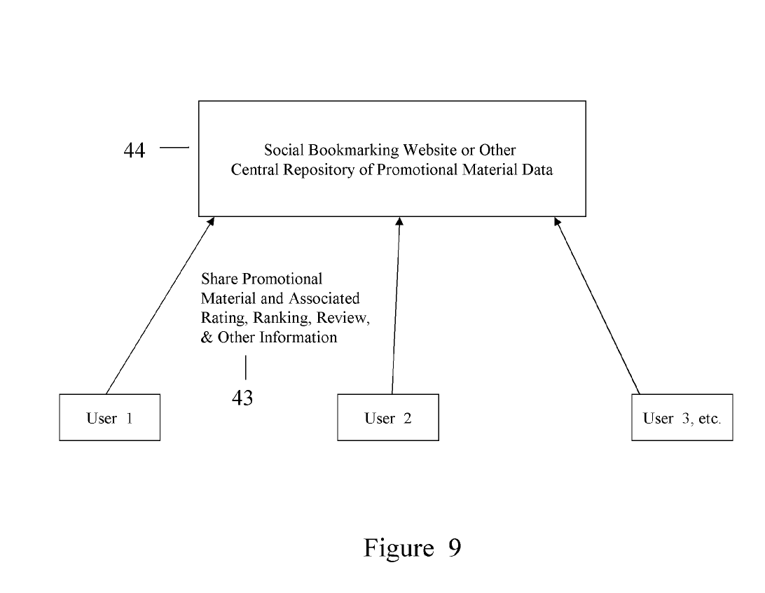

As shown in FIGS. 8 and 9, by performing sharing step 43 a user can share a piece of promotional material, list of promotional materials, and/or associated information with another user by sending it to the other user via email, or via an internal messaging system, forums, email lists, groups, or any other suitable method, and can thereafter interact with the other user via any suitable method including those discussed above. A user can also share promotional material with friends or other users through an online social bookmarking website 44 or other central repository of promotional material data, such as that exemplified by the website http://del.icio.us. The data is communicated to the central repository using any suitable data communication method such as are known in the art, including but not limited to XMLHttpRequest, HTTP form submission, HTTP request, SOAP, TCP/IP, remote procedure call, call to a remote database with a SQL statement, or other networking protocol.

Alternatively, instead of the data residing in a central repository, the data can be stored using cookies, or on local machines, and shared with other users in a peer-to-peer arrangement. The user controls the access that others have to a given piece of promotional material or set of promotional materials on his/her list, or to an entire list of his/her promotional materials, by making the promotional material public to all users, accessible to a subset of other users, or accessible only to him or herself.

Searching for Other Users, and for Lists of Promotional Material Other Users Have Selected

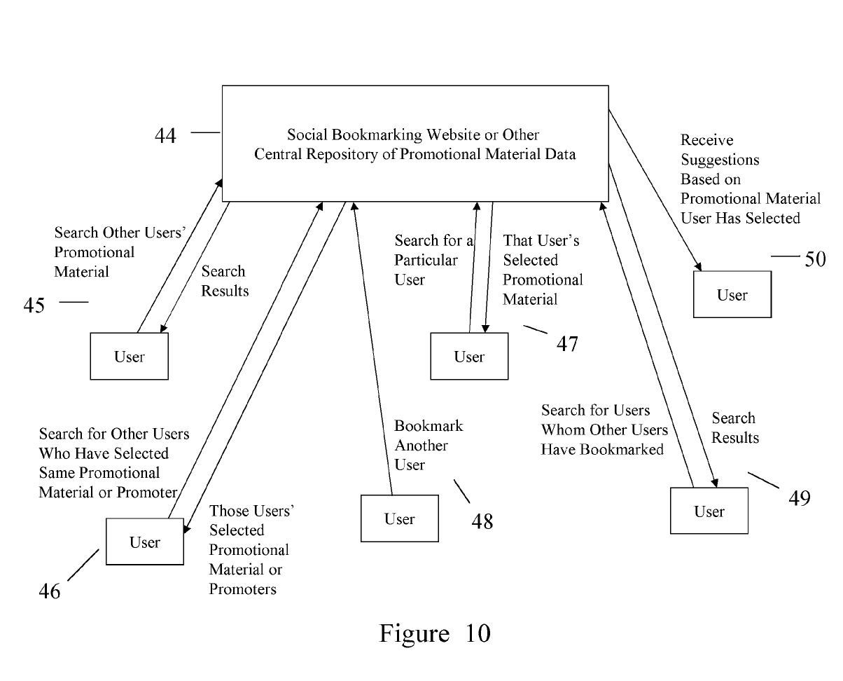

As shown in FIG. 10, once a user has access to a list of promotional material selected by another, by performing search other users' promotional material step 45 the user can search the other user's list based on various criteria, to the extent possible given that some lists may be public and others private. The search criteria include but are not limited to: The rating or ranking given to the promotional material by the other user; descriptive tags or labels assigned to promotional material by the other user; or a portion of text in a review of promotional material or a promoter done by the other user.

Additionally, a user can search on a more global level—that is, by performing search for other users step 46, a user can first search a collection of promotional material lists for those lists done by a particular user, and then search or browse through that user's selected promotional material. Additionally, by performing search for particular users step 47, a user can search for other users who have selected one or more promotional materials from the same promoters as he or she, and then see what other promotional material they have selected and/or utilized. By performing bookmark user step 48, a user can then bookmark one or more of these users, promotional material, thematic lists, hierarchically organized selected promotional material, or other data, so that they can refer to them later. By performing search for other bookmarked users step 49, a user can also see which users other users have bookmarked, thus creating a web of inter-related users defined by the promotional material they have selected and (optionally) utilized. Users enter their user profile information, including but not limited to their name, physical address, email address, and other personal information, when registering to use the system. Users can elect to share or not share personal data on user profiles, including demographic information and/or personal likes, dislikes, essays, etc.

Receiving Suggestions Based on Promotional Material You Have Selected

Continuing with FIG. 10, in receive suggestions step 50 the user can receive suggestions for other promotional material based on promotional material he/she has selected and/or utilized, and their correlation to promotional material that other users have selected and/or utilized. For example, if the user selected and/or utilized promotional material from ABC Financial, the system surveys the other promotional material selected by users who selected and/or utilized ABC Financial, and suggests to the user that “other users who got car loans from ABC Financial also liked Merv's Bail Bonds”.

More specifically, if a user has selected promotional material A, and there are N users U₁-U_{N} who have also selected promotional material A, then there is a set of promotional materials S that contains all of the promotional material that users U₁-U_{N} have selected. It is possible, based on default or user-defined criteria, to determine in descending order the most popular pieces of promotional material in S, or alternately from the set of all promotional materials from all users. User A can set limiting criteria for these promotional materials, so that for example, he or she did not get promotional material for a particular type of product/service; or, so that a particular type of product/service was given preferential treatment. Limiting criteria might be for any of the things mentioned above regarding ratings/categorization, or for a threshold of popularity, or for pre-defined categories.

Embodiment Wherein the Invention Places the Promotional Material as an Annotation

FIG. 11 illustrates the steps in the process of the invention wherein promotional material is annotated onto the webpage by the invention, and then selected, stored, accessed, and managed by the user. In FIG. 11, data collection step 10, analysis and annotation step 11, database 12, and presentation step 13 are similar to those shown and described for FIG. 1, except that analysis and annotation step 11 involves analyzing the webpage or other data collection to determine suitable promotional materials from database 12 with which to annotate the webpage or other data collection, and presentation step 13 involves presenting the webpage or other data collection to the user with said promotional material annotations thereon, so that the user can then select his/her desired promotional material. The rest of the steps shown in FIG. 11 are the same as those shown in FIG. 7.

Advertisements and Coupons as Promotional Material

As discussed earlier, advertisements are an example of a promotional material associated with the methods and systems of the invention. That is, online advertisements can be selected by the user, stored in the data storage means, and utilized/managed by the user in the ways described above.

Coupons are another example of a promotional material associated with the methods and systems of the invention. A coupon can be a promotional code that is used for a discount on a particular product, a traditional paper coupon that can be printed out, or a cut out from a circular that can be sent in by the user and stored in the central repository, or traded by one user to another user. Coupons can also be selected by the user, stored in the data storage means, and utilized/managed by the user in the ways described above. However, because of their nature, coupons can be selected and utilized by the user in additional ways, including the following:

In one selection embodiment, when a user passes his/her mouse or other pointing device over an item on a webpage or other data collection, a pop-up appears that contains a coupon or a link to a coupon. The user can then click on or otherwise select the coupon or coupon link. As non-limiting examples, the user might pass his/her mouse over a particular camera model name, and see a pop-up containing a $25 off coupon for that camera. Or, a user might pass his/her mouse over a particular country name, and see a pop-up containing a 25% off coupon for air travel to that country. Or, a user might pass his/her mouse over a particular advertisement, and see a pop-up containing a $25 off coupon for the product in the advertisement, said coupon being drawn from a central coupon repository. Thus, the advertisement itself is being annotated. It should be understood, of course, that any coupon accessed using the above means can be stored and utilized in any of the ways previously described for promotional material.

With regard to sharing coupons with others, users can gain points or other incentives for submitting coupons to a central repository or sharing them via a peer-to-peer network. Users can redeem their accumulated points or incentives for coupons, money, credit at partner or related sites, products, or other items. Alternatively, points can factor into a calculation of seniority, rank, or reputation on the site, with or without further benefit.

The coupon sharing site/repository contains coupons freely available to all, which primarily comprise unlimited use manufacturer's coupons submitted by users or by the manufacturers themselves; as well as limited use coupons, which are available either for a fee (for example, the system can take a certain percentage of the savings), or for a certain number of points. Users can earn these points by submitting coupons to the site, spending a certain amount of time on the site, helping out other users, answering questions in forums, having popular lists or blogs, or other means. Trades between users can be for free, as a swap, for money, or to earn points or other incentives that can be redeemed at a later date.

Ramifications and Scope

While the above description contains many specificities, these shall not be construed as limitations on the scope of the invention, but rather as exemplifications of embodiments thereof. Many other variations are possible without departing from the spirit of the invention. Examples of just a few of the possible variations follow:

A user could optionally specify additional attributes relating to the data, or preferences about the way in which the data is to be annotated. These additional attributes and preferences control the resources used for the annotation step in the process (i.e., the databases that the collection of data is compared against), and the output of the annotation step (i.e., what is presented when the user clicks on or otherwise accesses an annotation. It can be appreciated that a user can either enter the additional attributes and preferences each time each time he goes through the process, or the additional attributes can be supplied from previous inputs that have become part of a previously-created user profile. For instance, the user could specify the source language of the data, or the desired language or format of the annotations. The user could specify that the program should be aware of special terminology, or reference texts. For instance, a lawyer wishing to annotate a legal brief could specify that a legal dictionary be included in the databases searched in order to better annotate legal jargon contained in the legal brief; or request that references to case law in the legal brief (e.g., Brown v. Board of Education) be annotated with links to reference material about the particular case or other appropriate reference material; or request that the annotations be made in French. Likewise, a medical student could specify an entirely different set of preferences to annotate a medical journal article—e.g., that medically-oriented databases be consulted for the annotation step, or that the resulting annotations display specific, medically-useful characteristics when accessed by the user. The user could specify that images or video, tactile feedback (e.g., in the form of a rumble pack), audio, olfactory, taste-related, or other feedback be included when the annotations are presented to, or selected by, the user.

In analysis and annotation step 11, the process could look for individual words or groups of words, sentence constructions, idioms, jargon, a particular verb conjugation or grammatical construct, or references to external material (e.g., case law, medical experiments, publications, etc.) or people. Upon finding a localized instance of data to be annotated in accordance with the preferences (either specified or default), an annotation would be added to the data.

The presence of an annotation could be indicated by a superscript, a subscript, format change (possibly but not necessarily including italics, bold text, typeface or size changes, highlighting, etc.), a graphic, audio indication, mark-up, or other method. Alternatively, it might not be overtly indicated. The annotation itself could take the form of a footnote, an endnote, a sidebar, inline text delimited by parentheses or brackets, sound file, image, hyperlink, executable code, or commands recognized by an industrial robot, pacemaker, or automated drug delivery system.

Annotations could be in the form of translations for foreign words, definitions for words in the same language, grammatical notes, examples of usage, images, photographs, references to supplemental information, text explanations, hyperlinks, audio clips, musical scores, video, scents, tactile feedback, executable programs, commands for open or proprietary systems, other forms, or a combination of any of the above.

Depending on the type of annotation, users could use the annotations in a variety of ways, in addition to the embodiment described above (wherein a user selects unfamiliar vocabulary from a foreign language publication, then learns the vocabulary interactively in an automatically generated quiz). For instance, a user curious about an obscure court case mentioned in a news article could choose to follow a hyperlink added as an annotation to the original text, and review supplementary material provided elsewhere. Or, the writer of a journal article could automatically generate a bibliography, selecting only appropriate items. The invention also has application in the medical field: medical data would flow from instruments such as heart rate monitors, blood pressure monitors, electroencephalographs, etc. into a patient's “electronic chart”. The process would annotate this medical data by comparing it against internal or external databases. The doctor could select an annotation from the chart—say, an annotation that specifies a particular drug and dosage to address a high blood pressure condition which the process identified in the medical data—and then take an action like automatically adding the drug to a patient's IV.

A list of annotations or a corresponding automatically-generated methodology for use (e.g., a quiz or instructions to a pacemaker) could be saved, and used again later on the same or different media, in the same or in a different format. For instance, a quiz could be generated by selecting unknown words from an annotated foreign language website, then this quiz could be accessed later over a handheld device such as a mobile phone or PDA, or the same data could be utilized in a different manner at the same or a later time. Likewise, a user could be able to view the results of past usage, and modify the list of selections, or set up the process to automatically alter it based on performance. A teacher could be able to select difficult words from a source text and have his or her students practice those words using a variety of different drills.

In addition to the vocabulary quiz in the embodiment discussed above, the following are examples of different types of automatically generated quizzes which could be used in a context in which the annotations were used to learn information. The user could be asked multiple-choice questions, be required to fill in blanks with different conjugations, or provide the correct translation for a particular word or phrase. The user could be presented with the initial data and asked for the annotation (or the reverse), with or without audio or graphic clues. The quiz could utilize speech recognition technology to determine the accuracy of a spoken response, or require the user to diagram a sentence. The annotations could be organized into a crossword puzzle or word game. Graphical annotations could be organized into a game of solitaire, or three dimensional puzzle. A user could reproduce an audio clip through a MIDI connection, or identify a musical score from a few bars.

The system could be delivered as a web application installed on a server and publicly accessed over the Internet, or as a standalone software application, a plugin for another software product (e.g., browser, word processor, music composing software, etc.), a distributed application, a dedicated embedded device, an embedded application for a handheld device or cell phone, expert system, artificial intelligence, or through another method.

The data used to generate annotations could be stored in one or more databases, files, file systems, embedded ROM chips, or culled from sources over the Internet, local resources accessed over an intranet, experts consulted in real-time or asynchronously, other sources, or a combination of any of the above.

A doctor could use an implementation to automatically analyze a patient's medical record. Annotations could be in the form of recommendations for treatment, links to journal articles, contact information for the physician who had made a change in treatment, or commands which could automatically be sent to medical equipment (e.g., for the delivery of drugs). This information could be culled from medical studies, information provided by pharmaceutical companies, observations by other staff members, insurance information, medical databases, hospital databases, and possibly modified by the doctor's personal preferences for one treatment option over another. The doctor could select several annotations, and these annotations could be reviewed by other doctors or nurses, or acted upon by automated machinery.

An engineer could use an implementation to automatically analyze a piece of code. Annotations could be in the form of documentation, sample code, articles relating to programming topics, references to locations where a function is called, comments/markup by other programmers, or entries in a bug database indicating problems with the analyzed section. The engineer could select some of these annotations for the purposes of reference, preparation for a code review, or to review unfamiliar programming concepts, constructs, or API calls. The annotations could be used in the form of a tutorial, programming test, or the creation of an automated testing suite (e.g., annotations would indicate bugs or inefficiencies, the programmer would select one or more to work on, and upon completion automatically start an automated battery of test cases), or other method.

A human resources department could use an implementation to automatically analyze a resume. Annotations could be in the form of contact information for educational institutions, prior work environments, or references. Clicking on a button would automatically place a phone call or send an email to the specified contact. Skills desired by different areas of the organization could be highlighted, with contact information for the project leaders included. The human resources employee could then select certain annotations, and send them to managers who would review them and make decisions on whether or not to interview a candidate. The managers could then review these lists of information before interviewing a candidate.

A musician could use an implementation to automatically analyze a piece of sheet music, or a musical track. Annotations could be in the form of an audio clip (either synthesized or from a library of audio clips), or could display similarities between a section of music and other works. The musician could select annotations referring to areas of interest (or of particular difficulty) in the music, then practice using a custom interface and MIDI instrument.

A trainee's responses to a standardized training system could be automatically analyzed, with mistakes or areas for improvement annotated. The system would then allow the trainee (or a manager) to select specific areas on which to focus, and would then test the trainee specifically on those areas.

Regarding the selection of online promotional material, it should be understood that there are many different ways to select promotional material, besides clicking on it as discussed earlier. Selection can be by mouse click, but it can alternatively be by voice command, physical gesture, touch pad, musical note, key stroke, command or option key, joystick, or other suitable means. As a result of the selection, the inventive method and system saves the promotional material to a database, and optionally transfers the user to another site (i.e., normal hyperlink operation) and/or alters the current page's display using Javascript, Flash, Java applet, ActiveX control, PDF reader, browser widget, or other method. Said another way, a user can save promotional material to his/her list without actually going to the website underlying the promotional material.

Accordingly, the scope of the invention should be determined not by the embodiments illustrated, but by the appended claims and their legal equivalents.

What is claimed is:

1. A process for managing user-selected online promotional material, comprising the steps of:
(a) selecting, by a user, online promotional material;
(b) storing the promotional material in a data storage means;
(c) accessing, by the user, said data storage means;
(d) utilizing, by the user, said data storage means to perform a task.

2. The process of claim 1, wherein before said selecting step, said process also comprises the steps of:
specifying a data collection to be annotated;
analyzing at least one element of said data collection against a database and annotating said element with the promotional material when an association is found between said element and the promotional material in said database;
presenting said data collection with said annotated element.

3. The process of claim 1, wherein said promotional material is an advertisement.

4. The process of claim 3, wherein said data storage means contains a list of online advertisements that the user has previously selected.

5. The process of claim 3, wherein said utilizing step comprises saving the online advertisement to a more-permanent list of online advertisements.

6. The process of claim 3, wherein said utilizing step comprises the user moving the online advertisement to a location in a user-defined hierarchy.

7. The process of claim 3, wherein said utilizing step comprises the user tagging the online advertisement with a description.

8. The process of claim 3, wherein said utilizing step comprises the user rating the online advertisement or the advertiser making the online advertisement, based on at least one rating criterion.

9. The process of claim 8, wherein said utilizing step further comprises the user ranking the online advertisement or advertiser, based on its rating relative to the ratings of other online advertisements or advertisers.

10. The process of claim 3, wherein said utilizing step comprises the user ranking the online advertisement, or the advertiser making the online advertisement, based on the user's subjective judgment.

11. The process of claim 3, wherein said utilizing step comprises the user writing a review of the online advertisement, or the advertiser making the online advertisement.

12. The process of claim 3, wherein said utilizing step comprises placing the online advertisement in a list of bookmarks.

13. The process of claim 3, wherein said utilizing step comprises the user creating thematic lists of advertisements and placing the online advertisement in at least one of said thematic lists.

14. The process of claim 3, wherein said utilizing step comprises the user sharing the online advertisement with other users.

15. The process of claim 14, wherein the user also shares, with other users, information associated with the online advertisement.

16. The process of claim 3, wherein said process further comprises the user accessing online advertisements selected by another user.

17. The process of claim 16, wherein said process further comprises the user accessing information associated with the online advertisements selected by another user.

18. The process of claim 16, wherein the user searches the online advertisements selected by another user, based on at least one searching criterion.

19. The process of claim 17, wherein the user searches for another user who has selected the same online advertisement or advertiser as the user.

20. The process of claim 16, wherein the user searches for an online advertisement selected by a particular, predetermined other user.

21. The process of claim 17, wherein the user bookmarks another user.

22. The process of claim 17, wherein the user searches for users whom other users have bookmarked.

23. The process of claim 3, wherein said process further comprises the user receiving suggestions based on a correlation between the online advertisement the user has selected, and an online advertisement selected by another user.

24. The process of claim 1, wherein said promotional material is a coupon.

25. The process of claim 24, wherein said data storage means contains a list of online coupons that the user has previously selected.

26. The process of claim 24, wherein said utilizing step comprises saving the online coupon to a more-permanent list of online coupons.

27. The process of claim 24, wherein said utilizing step comprises the user moving the online coupon to a location in a user-defined hierarchy.

28. The process of claim 24, wherein said utilizing step comprises the user tagging the online coupon with a description.

29. The process of claim 24, wherein said utilizing step comprises the user rating the online coupon or the couponer making the online coupon, based on at least one rating criterion.

30. The process of claim 29, wherein said utilizing step further comprises the user ranking the online coupon or couponer, based on its rating relative to the ratings of other online coupons or couponers.

31. The process of claim 24, wherein said utilizing step comprises the user ranking the online coupon, or the couponer making the online coupon, based on the user's subjective judgment.

32. The process of claim 24, wherein said utilizing step comprises the user writing a review of the online coupon, or the couponer making the online coupon.

33. The process of claim 24, wherein said utilizing step comprises placing the online coupon in a list of bookmarks.

34. The process of claim 24, wherein said utilizing step comprises the user creating thematic lists of coupons and placing the online coupon in at least one of said thematic lists.

35. The process of claim 24, wherein said utilizing step comprises the user sharing the online coupon with other users.

36. The process of claim 35, wherein the user also shares, with other users, information associated with the online coupon.

37. The process of claim 24, wherein said process further comprises the user accessing online coupons selected by another user.

38. The process of claim 37, wherein said process further comprises the user accessing information associated with the online coupons selected by another user.

39. The process of claim 37, wherein the user searches the online coupons selected by another user, based on at least one searching criterion.

40. The process of claim 38, wherein the user searches for another user who has selected the same online coupon or couponer as the user.

41. The process of claim 37, wherein the user searches for an online coupon selected by a particular, predetermined other user.

42. The process of claim 38, wherein the user bookmarks another user.

43. The process of claim 38, wherein the user searches for users whom other users have bookmarked.

44. The process of claim 24, wherein said process further comprises the user receiving suggestions based on a correlation between the online coupon the user has selected, and an online coupon selected by another user.
